(19) United States
(12) Patent Application Publication
(10) Pub. No.: US 2015/0335202 A1
(43) Pub. Date: Nov. 26, 2015

(54) PORTABLE FOOD WARMING DEVICE

(71) Applicant: HAVEN INNOVATION, INC,, Grand Haven, MI (US)

(72) Inventors: Donald W. Wisner, Grand Haven, MI (US); Terry L. Plumert, Grand Haven, MI (US)

(21) Appl. No.: 14/758,867

(22) PCT Filed: Jan. 3, 2014
(86) PCT No.: PCT/US14/10200

§ 371 Date: Jul. 1, 2015

Related U.S. Application Data
(60) Provisional application No. 61/748,967, filed on Jan. 4, 2013.

(51) Int. Cl. A47J 39/02; H05B 3/30; A47J 36/24; H05B 3/68

(52) U.S. Cl. CPC A47J 39/02; H05B 3/686; H05B 3/30; A47J 36/2483

(57) ABSTRACT

A portable food heating device includes a soft-walled, flexible enclosure and a heating element within the enclosure for cooking a food item and maintaining the food item within a desired temperature range. The device includes an opening and a lid covering the opening. The heating element may be connected within a heating tray that is supported on the enclosure. The heating tray may be positioned within the enclosure. In one embodiment, the heating tray is not attached to the enclosure, such that they tray may be removed from the enclosure and used outside the enclosure. The heating tray includes a controller, such as a thermal switch, that is programmed to maintain the heating tray within a desired temperature range.

### BACKGROUND OF THE INVENTION

Heating a meal can be a significant inconvenience. Professional drivers, delivery people, sales people and others that do not work in a fixed location generally do not have access to equipment for heating their meals. They must travel to a fixed location to find heating equipment, or purchase their meals from a third party. Others, such as those working in an office environment, have ready access to heating equipment such as microwaves and conventional ovens, but may need to spend a substantial portion of their lunch period waiting for their food to cook. In some situations, people may need to wait in line in order to even use the heating equipment.

Various portable heating devices are known, including slow cookers, which typically include a rigid, bowl shaped housing, and a lid capable of covering the open end thereof the bowl. A heating element is embedded within the bowl shaped housing, such as underneath the floor of the housing. A power cord and a control switch are located on the outside of the housing, such that a user can move the device to a desired location, plug it in and set the temperature to a desired level. These and other so-called portable heating devices, however, are not convenient for highly portable applications where it is desirable to heat, or reheat, a single serving meal.

### SUMMARY OF THE INVENTION

The current invention provides a device for heating food that includes a portable housing and a controlled heating system supported within the housing. In one embodiment, the heating system includes a tray, a heating element and a thermal switch. The heating element is operable to heat the tray, and the thermal switch regulates the temperature of the tray.

In one embodiment, the housing is a portable unit, such as a structured, but flexible, cooler type bag or container. The housing may include a bottom wall and side walls extending upwardly from the bottom wall to form an opening, and a lid connected to the side walls capable of enclosing the opening. The side walls, bottom wall and lid may be insulated. The tray may be mounted to the bottom wall, and may include a power cord for connecting the tray to a standard wall outlet. The housing may include a pocket or other portion for containing the power cord when the cord is not in use.

The present invention provides a device that enables: (1) the insertion of a cold food item, (2) enclosing the food item in an insulated space to keep the food item cold, (3) transporting the device containing the food item to a desired location, such as a person's place of business, and (4) heating the food item—at any time that it is desired to heat the food item—within the enclosure by simply plugging the device into a standard outlet.

These and other objects, advantages, and features of the invention will be readily understood and appreciated by reference to the detailed description of the current embodiment and the drawings.

### BRIEF DESCRIPTION OF THE DRAWINGS

FIG. 1 is a front perspective view of a portable food warming device according to one embodiment of the present invention.

FIG. 2 is rear perspective view thereof.

FIG. 3 is a rear perspective view thereof with the power cord stored.

FIG. 4 is front perspective view with the lid opened.

FIG. 5 is a front perspective view with the lid opened and a food item placed in the enclosure.

FIG. 6 is an exploded view of the heating assembly.

FIG. 7 is a top view of the heating assembly.

FIG. 8 is a side view of the heating assembly.

### DETAILED DESCRIPTION OF THE CURRENT EMBODIMENT

I. Overview

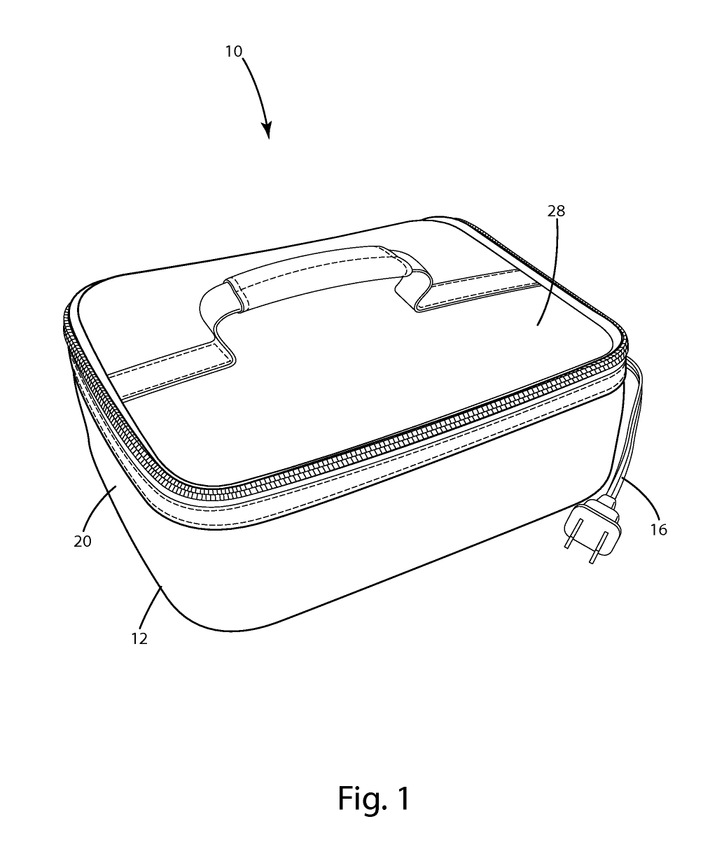

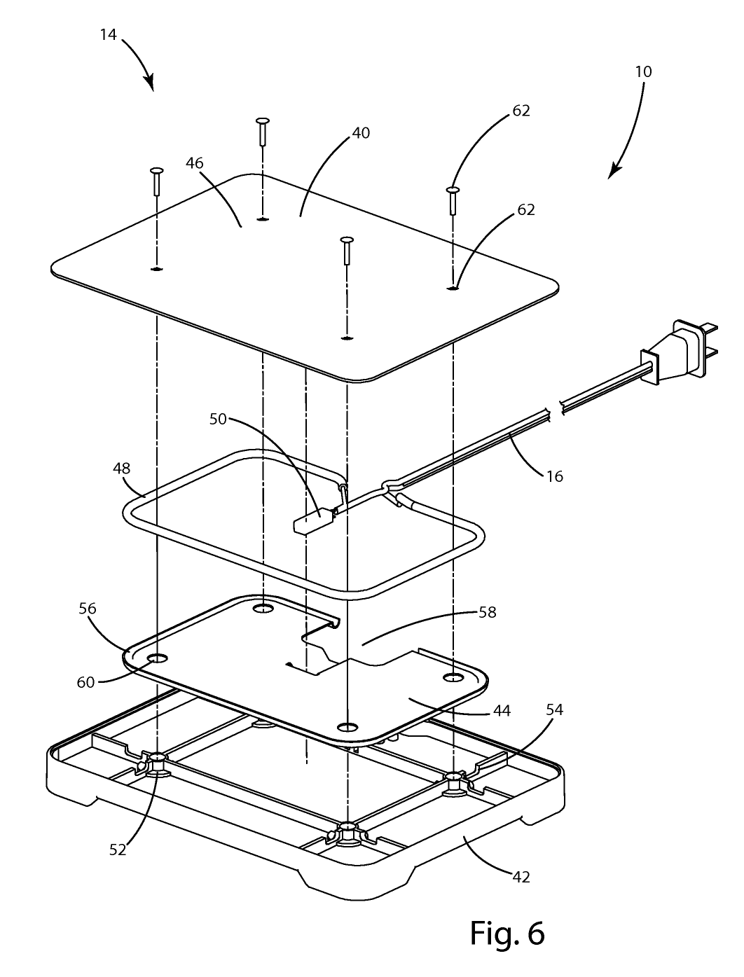

A portable food warming device designed to insulate, transport and heat a food item is shown in FIG. 1 and generally designated 10. In the illustrated embodiment, the device or container 10 has an enclosure or housing 12, and a heating assembly 14 (shown in FIGS. 6-8). The heating assembly 14 may be mounted or supported within the enclosure 12, and may include a power cord 16 extending from the heating assembly 14 to the exterior of the enclosure 12 for electrically connecting the heating assembly 14 to a power supply.

II. Structure

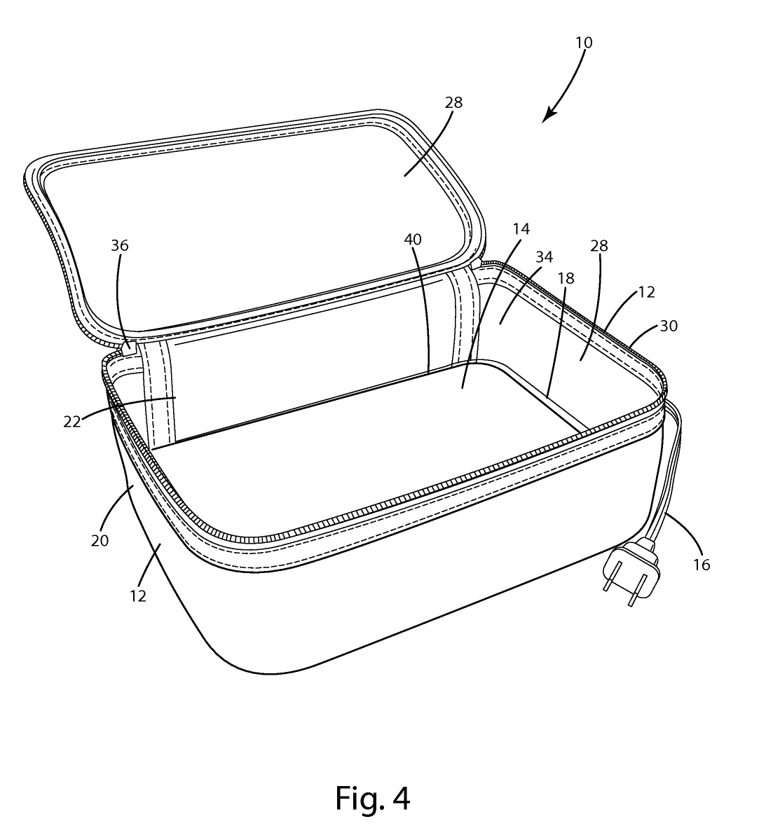

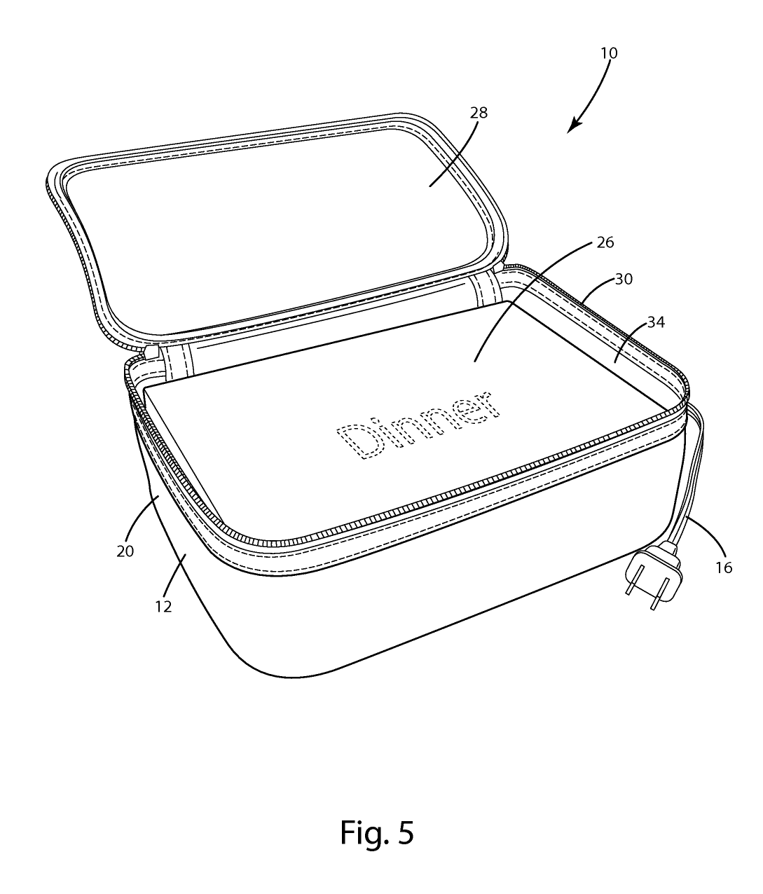

As shown in FIGS. 1-5, the enclosure 12 is a small portable enclosure including a bottom wall 18, a side wall 20 extending upwardly from the bottom wall 18 and forming a space 22 having an opening 24 for receiving a food item 26. A top wall 28 may form a lid that connects to the upper edge 30 of the side wall 20 for enclosing the internal space 22 and enclosing a food item 26 within the space 22. In one embodiment, the walls 18, 20 and 28 may be formed from a variety of materials. For instance, the walls may be formed as a flexible, soft-sided cooler, including an outer fabric layer 32, a padded insulation layer (not shown), a structural layer (not shown) and an inner layer 34. In the illustrated embodiment, the inner layer 34 is a reflective layer, such as an aluminum foil layer, for increasing the insulative properties of the enclosure. In another embodiment, the enclosure walls may include a different arrangement of layers, or be made from other materials, such as plastic. In the illustrated embodiment, the top wall 28 forms a lid that attaches to the upper edge 30 of the side wall 20 with a zipper 36 (or Velcro™ or another type of fastening device). In another embodiment, the lid may be located on the side wall 20, or within a portion of the side wall 20, and may be attached by another conventional attachment method that enables opening and closing the device or that can be removed to provide access to the internal space 22. As shown in FIG. 5, the enclosure 12 may be sized to fit the typical sized boxed, frozen dinner, although the sizing may be changed as desired from application to application.

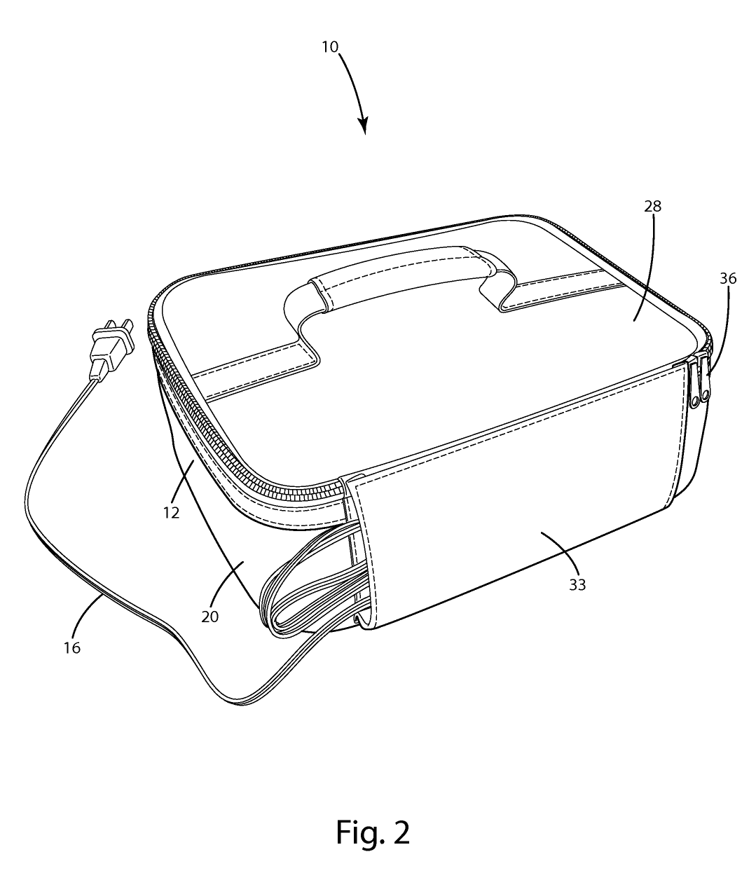

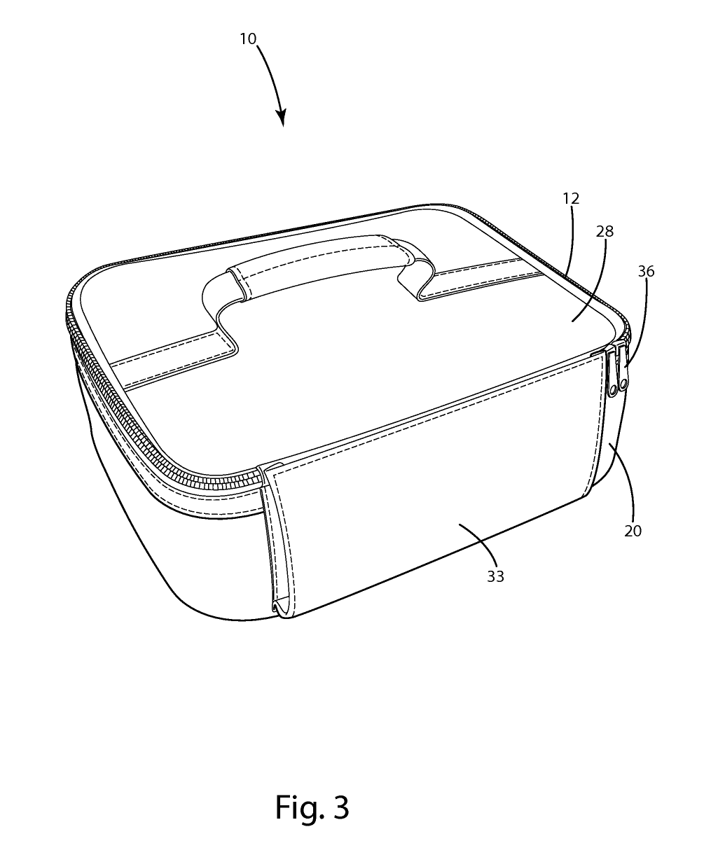

As shown in FIGS. 2 and 3, the housing or enclosure 12 may include a storage compartment for the power cord 16. In one embodiment, the compartment is a pocket 33 attached to the side wall 20, such that the power cord 16 can be inserted into the pocket (i.e., between the pocket 33 and the outer surface of the side wall 20). In the illustrated embodiment, the pocket 33 is a layer of material that is sewn to the side wall 20 about three sides, leaving a fourth side open to permit removal of the power cord 16. The side wall 20 may include a passageway for the electric cord from the heating element 48 to the outside of the enclosure within the pocket 33. In another embodiment, the pocket 33 or another portion of the enclosure may include space for one or more batteries for powering the device. The batteries may be included as a supplement to a power cord 16, or as an alternative.

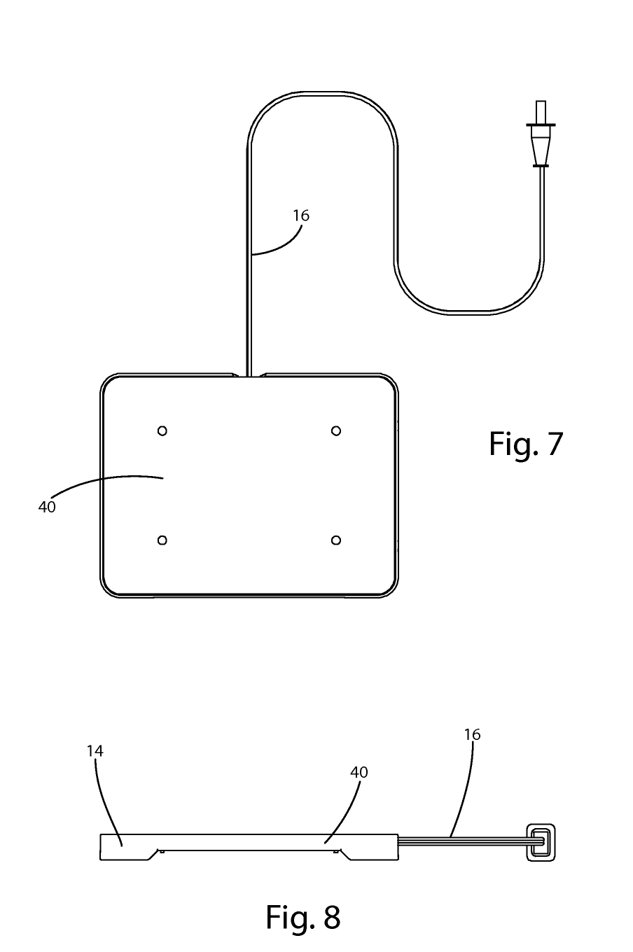

In one embodiment, the heating assembly 14 includes a tray 40 that includes a base 42, a retainer 44, a plate 46, a heating element 48 and a thermal switch 50. As illustrated in FIG. 6, the base 42 is a generally flat, structural member that can be attached to the bottom wall 18, or another desired surface, of the housing 12. The base 42 may include a number of bosses 52 formed integrally with the base 42. The base 42 may further include one or more recesses 54 for receiving portions of the retainer 44. The retainer 44 is also a generally flat plate that may be formed from a variety of materials. As shown, the retainer 44 includes a channel 56 extending around the periphery of the retainer 44 for receiving the heating element 48. The retainer 44 further includes a cutout 58 and a number of holes 60. The holes 60 may each align with one of the bosses 52 in the base 42 when the retainer 44 is mounted on the base 42. The plate 46 may be a flat metal plate that is sized the same as the base 42 to fit over the base 42 and extend to the periphery of the base 42. The plate 46 may include holes 62 that align with the holes 60 in the retainer 44 and the bosses 52. The heating element 48 may be an electric heat source, such as a heater coil, which is positioned in the channel 56 of the retainer 44, such that the heating element 48 is located on the underside of the plate 46. A thermal switch 50 may be connected to the heating element 48. A power cord 16 is connected to the heating element 48 and the thermal switch 50. As illustrated, the thermal switch 50 is positioned such that it fits within the cutout 58 in the retainer 44. The tray 40 can be assembled—as shown in FIGS. 7 and 8, with the plate 46 connected to the base 42 via rivets 64 or other fasteners extending through the holes 62 of the plate, the holes 60 in the retainer 44 and into the bosses 52 in the base 42. The retainer 44, heating element 48 and thermal switch 50 may be sandwiched between the plate 46 and the base 42.

The thermal switch 50, also known as a thermal cutout, may include a sensor capable of measuring the temperature of the thermal switch 50, and thus the temperature of the heating element 48 and plate 46 adjacent to the thermal switch 50. The thermal switch 50 may cut off power to the heating element 48 when the measured temperature reaches a predetermined amount. In one embodiment, the thermal switch 50 maintains the temperature of the plate between about 160 degrees F. and 200 degrees F. In a more particular embodiment, the thermal switch maintains the temperature of the plate between about 165 degrees F. and 185 degrees F. The thermal switch may cut off power to the heating element 48 when the temperature reaches a predetermined upper limit, and it may send power to the heating element when the temperature falls below a predetermined lower limit temperature. The power cord 16 may be a standard power cord for a wall outlet.

Although the tray 40 may be attached to the bottom wall 18, or another desired surface, of the housing 12, in one embodiment, the tray 40 is not attached to the housing 12 to enable easy removal of the tray 40 from the housing 12, for example, for purposes of cleaning. In the illustrated embodiment, the plate 46 and the base 42 may be sealed together to protect and enclose the heating element 48 and the thermal switch 50. The tray 40 may be sized to fit within the housing 12. In one embodiment, the tray 40 includes an outer perimeter 49 that is slightly smaller than the size of the bottom wall 18 to enable the tray to fit inside the housing 12 wherein the tray 40 can rest loosely on the bottom wall 18.

III. Operation

In one embodiment, the heating element 48 operates using standard residential line voltage, via the power cord 16. When the cord is plugged in, the thermal switch 50 electrically limits the heat output so that the maximum temperature within the internal space 22 does not exceed a predetermined maximum temperature, such as 210 degrees F. Likewise, the heating element 48 may be selected such that, when sized to fit into the internal space 22 and within the plate 46, the maximum power of the heater will not exceed the flashpoint of the surrounding materials forming the enclosure 12 or that of any food products of food product containers. As a result of this heater selection, the heater will not ignite the surrounding materials even in the event of a malfunction of the thermal switch 50 in a closed, electrically conducting, state. In one embodiment, wherein the plate is approximately 6 in×8 in and the internal space 22 within the enclosure is approximately 144 in³ the heater is a 45 W heater.

In one embodiment, the heater is capable of supplying sufficient heat to bring, for example, a frozen 12-14 ounce meal to a serving temperature of 165+ degrees F. within a few hours. As noted above, in one operating mode, the thermal switch 50 automatically regulates the temperature of the heater plate in the range of about 165-220 degrees F. and more particularly between about 185-210 degrees F. due to the predetermined setting of the thermal switch 50. Alternative settings may be used in order to vary the heat levels as desired. The combination of the heating element 48 and tray with an insulated portable container serves to keep cold food placed in the internal space 22 cold for a period of time until the heater is plugged in, and then heats the food item in the same container. During use, the portable container serves to isolate the heater from environmental conditions that are detrimental to the heating process and it also captures and retains the latent heat, all of which allow for consistent results.

In one embodiment, the tray 40 may also include a controller—in addition to or as a substitute for the thermal switch—for measuring and maintaining the heating surface temperatures, particularly the surface temperature of the tray 40. In such an embodiment, the controller may include a circuit board mounted to the tray and electrically connected to the power cord 16 and the heating element 48. The controller may be programmed to operate the heating element 48.

In another embodiment, the temperature of the tray 40 may be regulated or controlled in a different manner. For example, a temperature sensing device may be included in connection with the tray 40 that directly measures the temperature of a food product placed on top of the plate 46. For instance, a non-contacting temperature probe such as a thermal imaging or other infrared device may be utilized to monitor the temperature of a food product or pre-packaged item on the tray 40. Alternately, a non-contacting probe may be used in conjunction with a thermistor, thermocouple, bi-metal based or other temperature sensing device located on the heating surface to measure the temperature difference between the item and the heating surface.

The plate 46 or other portions 4 of the tray 40, may additionally contain a strain gauge, proximity sensor, through-beam element, microswitch or other similar element, either contacting or non-contacting, to detect the presence of an item on the tray. A strain gauge can be employed to measure the mass of the item or items placed on it and adjust the equilibrium state time period.

In an embodiment including a controller, the controller may be programmed to cook the food item for a desired time period. The cooking time may be a predetermined time period, or the cooking time may be automatically determined based on the characteristics of the particular food item place in the container 10. In this embodiment, when the device 10 is first turned on (for instance, by plugging the device 10 into a power source), the controller may operate the heating element 48 to warm the tray to a programmed holding temperature. In one embodiment, the holding temperature is between 100 and 190 deg F, and in a more particular embodiment the holding temperature is 110 deg F. As the tray heats, the heater 48 is allowed to use 100% heater power. When the tray 40 reaches its initial holding temperature, the controller operates the heater 48 to run on a duty cycle, such that heater 48 is allowed to only use a portion of its full power to maintain the tray 40 at the initial holding temperature. In one embodiment, the tray operates at 33% of full power in this duty cycle, for instance, by cycling between on for 1 second and off for 2 seconds.

When a food product is placed in the enclosure 22 on the tray 40, the heater 48 may be activated to cook the food product. In one embodiment, the device 10 may include a switch that can be manually pressed to initiate a cook cycle, also referred to herein as a “rethermalization cycle”. In another embodiment, the rethermalization cycle may be automatically activated by the controller. For example, when a food product is placed in the enclosure 22 on the tray 40, the heat energy of the tray 40 is transferred into the food item drawing the temperature of tray 40 down. The temperature of the tray may be measured, for example, by a the thermistor positioned adjacent to the tray, such as in the same position as the thermal switch 50 shown in the drawings. This downward temperature trend of tray 40 is plotted by the controller. If this downward trend exceeds the allowed temperature trend, a rethermalization cycle is initiated. Put another way, if the temperature drop is greater than a predetermined rate, then the controller automatically initiates a rethermalization cycle.

When the rethermalization cycle has been initiated, the heater is operated to raise the temperature of the food. At this point, the heater 48 may be operated at 100% of the available heater wattage to bring the measured temperature of the tray 40 to a predetermined rethermalization temperature range. In one embodiment, this rethermalization temperature range is between about 205 and 212 degrees F. The controller may also initiate timers and record heating trends throughout the heating cycle to determine, for example, rethermalization duration (i.e., the duration of time necessary to raise the tray to the rethermalization temperature) and malfunction determination (i.e., a timer that follows the amount of time the heater 48 is operated at 100%, if exceeded may indicate a heater malfunction.)

When the temperature sensor indicates that the tray 40 has reached the predetermined rethermalization temperature, the controller initiates a duty cycle. In other words, it reduces the power to the heater 48 in an attempt to maintain the measured temperature of the tray 40 within the rethermalization temperature range. In one embodiment, the controller periodically checks the measured temperature of the tray, and operates the heater as a function of the measured temperature. At each interval, if the measured temperature of the tray is below the rethermalization temperature range, then the duty cycle is increased by a predetermined increment. Likewise, if the measured temperature of the tray 40 is above the rethermalization temperature range, then the duty cycle is decreased by a predetermined increment. In most cases, a reduction of power to heater 48 will continue as the food item increases in temperature. The controller also measures the duration that the heater remains at any particular duty cycle. As the temperature of the food item increases, the controller will reach a point where the duty cycle necessary to maintain the food item within the rethermalization temperature range will no longer change. When the reduction of power applied to heater 48 stops changing, it has been found that this is an indication that the food temperature is nearing a desired serving temperature, such as 165 degrees F. If the power to heater 48 does not change for a predetermined period of time, then the controller determines that the food item has reached the serving temperature. In one embodiment, the controller may then set the tray temperature to the hold temperature of 175 degrees F., or another hold temperature, and operates the heater on a hold duty cycle to maintain the temperature of the tray within a range of temperatures near the hold temperature of 175 degrees F.

In one embodiment, the controller may initiate a “final check” to determine whether the food item has been properly cooked prior to initiating the hold duty cycle. In this embodiment, the controller may operate the heater to completely cut power to the heater, or to substantially reduce the power to the heater, and monitoring the rate at which the temperature falls and/or the amount that the temperature falls. If the temperature falls at greater than a predetermined threshold rate, then the controller would determine that the food item is not sufficiently cooked, and would initiate a secondary rethermalization cycle. This secondary rethermalization cycle may include operating the heater at 100% for a predetermined time period depending on the rate at which the temperature fell. For example, if the measured temperature of the tray 40 falls 20 degrees below the 175 degree hold temperature within a preset time period, then the controller may operate the heater to initiate a secondary rethermalization cycle with the heater at 100% power for 30 minutes. After the secondary rethermalization cycle, if any, the controller may initiate the hold duty cycle as noted above.

The heated food product on the tray now acts much like a heat battery, and can be maintained at the hold temperature until the user is ready to remove and consume the food product. In one embodiment, the hold temperature of the tray 40 is set at approximately between 140 deg F and 190 deg F. This temperature is low enough to not make the moisture that is in the food item to evaporate, and is high enough to allow the food item to be maintained at this temperature for extended periods of time without degrading the pathogenic safety of the food product.

The above noted method is one way of heating a food product and holding it at the desired hold temperature as a function of the temperature of the tray, and as a function of the particular food product that has been placed on the tray. Alternative heating and holding methods may also be used, including using the tray temperature, cook timer, loop timer, and other parameters, such as the actual measured temperature of the food product. In one embodiment, the controller may operate the heater 48 only to cook the food (i.e., without the initial holding temperature and without the final holding temperature), such that the cooking operation begins as soon as the device 10 is plugged in to a power source. Other embodiments may also be used to cook the food or simply hold a food item at a desired temperature.

1. A portable food warming device comprising:
a portable housing including a bottom wall, side walls extending upwardly from the bottom wall to form an opening, and a lid connected to the side walls capable of enclosing the opening, at least one of the bottom wall, side walls and lid including an insulation layer, at least one of the bottom wall, the side walls and the lid including a flexible fabric material;
a heating system supported within the housing and including a tray, a heating element and a thermal switch, wherein the heating element is operable to heat the tray, and the thermal switch regulates the temperature of the tray, wherein the tray is positioned on at least one of the bottom wall and the side walls, wherein the tray includes a power cord connected to the tray and capable of being connected to a standard wall outlet.

2. The portable food warming device of claim 1 wherein the housing includes a pocket or other portion for containing the power cord when the cord is not in use.

3. The portable food warming device of claim 2 wherein one of the side walls defines an opening extending through the side wall, the power cord extending through the opening.

4. The portable food warming device of claim 3 wherein the heating system is not attached to the housing, such that the heating system is removable from the housing.

5. The portable food warming device of claim 4 wherein the heating system includes a base, a plate and a heating element sandwiched between the base and the plate, the base and the plate sealed together to house the heating element in a sealed environment.

6. The portable food warming device of claim 5 wherein the thermal switch is programmed to maintain the temperature of the plate between about 165 degrees F. and 210 degrees F.

7. The portable food warming device of claim 6 wherein the side walls are flexible.

8. The portable food warming device of claim 7 wherein the side walls, lid and base are flexible.

9. The portable food warming device of claim 8 wherein the housing includes an exterior surface and an interior surface opposite the exterior surface, at least a portion of the interior surface including a foil layer.

10. The portable food warming device of claim 9 wherein at least one of the side walls, lid and base include an outer flexible fabric layer, an inner flexible foil layer and a flexible insulation layer sandwiched between the fabric layer and the foil layer.

11. A portable food heating device comprising:
an enclosure having a bottom wall, side walls and a lid, the bottom wall including an upper interior surface and a lower exterior surface opposite the interior surface, the sidewalls extending upwardly from the bottom wall to form an opening, the lid capable of closing the opening;
a tray positioned within the enclosure, above the upper surface of the bottom wall, the tray including a heating element and a controller; and
a power supply connected to the heating element for powering the heating element, wherein the controller maintains the temperature of the tray within a predetermined temperature range when the heating element is powered by the power supply.

12. The portable food heating device of claim 11 wherein the side walls are flexible.

13. The portable food heating device of claim 12 wherein the side walls each include an interior foil layer, an exterior fabric layer and an interior insulation layer.

14. The portable food heating device of claim 13 wherein the tray includes a base and an upper plate, the heating element and the controller sealed between the base and the upper plate.

15. The portable food heating device of claim 14 wherein the base is positioned on the upper surface of the bottom wall of the enclosure, but is not attached to the enclosure such that the tray is removable from the enclosure.

16. The portable food heating device of claim 15 wherein the power supply includes a power cord attached to the tray.

17. The portable food heating device of claim 16 wherein one of the side walls defines an opening extending therethrough, the power cord extending through the opening.

18. The portable food heating device of claim 17 wherein the controller maintains the temperature of the tray between about 165 degrees F. and 185 degrees F.

19. The portable food heating device of claim 11 wherein the controller is programmed to operate the heating element on a rethermalization cycle to raise the temperature of the tray to a predetermined rethermalization temperature range, and, upon reaching the rethermalization temperature range, the controller operates the heater on a duty cycle to maintain the temperature of the tray within the rethermalization temperature range, wherein the controller periodically determines whether the temperature of the tray is within the rethermalization temperature range, and adjusts the duty cycle to maintain the temperature of the tray within the rethermalization temperature range, wherein the controller monitors the duration for which the heater remains at a duty cycle, and initiates a hold duty cycle to maintain the temperature of the tray within a hold temperature range upon the heater remaining at a duty cycle for a period longer than a predetermined threshold duration.

20. A portable food heating device comprising:
a soft-walled, flexible enclosure including an opening and a lid covering the opening, at least one of the lid and the opening including structure for securing the lid over the opening, the soft-walled enclosure including a flexible insulation layer; and
a heating tray supported on the enclosure, the heating tray including a heating element and a controller connected between a base and a plate, the controller programmed to maintain the heating tray within a desired temperature range when the heating tray is activated, wherein the desired temperature range is between 165 F and 200 F.
